(19) United States
(12) Patent Application Publication
(10) Pub. No.: US 2010/0111814 A1
(43) Pub. Date: May 6, 2010

(54) Chirality-based separation of carbon nanotubes

(75) Inventors: Stephen K. Doorn, Los Alamos, NM (US); Michael J. O'Connell, San Jose, CA (US); Crystal G. Densmore, Los Alamos, NM (US); Hsing-lin Wang, Los Alamos, NM (US)

Correspondence Address: LOS ALAMOS NATIONAL SECURITY, LLC, LOS ALAMOS NATIONAL LABORATORY, PPO. BOX 1663, LC/IP, MS A187, LOS ALAMOS, NM, 87545, US

(73) Assignee: The Regents of the University of California

(21) Appl. No.: 11/639,937

(22) Filed: Dec. 14, 2006

Related U.S. Application Data
(60) Provisional application No. 60/762,819, filed on Jan. 27, 2006.

(51) Int. Cl. D01F 9/12; C09K 3/00; B01J 16/00

(52) U.S. Cl. 423/447.1; 422/164; 977/742; 977/845

(57) ABSTRACT

A mixture of carbon nanotubes is separated into fractions that are enriched with a desired chirality by exposing a solution or suspension of the carbon nanotubes to a separation medium. A portion of the mixture forms complexes with, and becomes attached to, the separation medium. Exposure to other reagents results in dissociation of the complexes and release of the nanotubes from the separation medium.

### RELATED APPLICATIONS

This application claims the benefit of U.S. Provisional Application No. 60/762,819 filed on Jan. 27, 2006, titled “Chirality-Based Separation of Carbon Nanotubes,” which is incorporated by reference herein.

### STATEMENT REGARDING FEDERAL RIGHTS

This invention was made with government support under Contract No. DE-AC51-06NA25396 awarded by the U.S. Department of Energy. The government has certain rights in the invention.

### FIELD OF THE INVENTION

The present invention relates generally to carbon nanotubes and more particularly to a method for separating carbon nanotubes into fractions based on chirality and electronic properties.

### BACKGROUND OF THE INVENTION

Carbon nanotubes (CNTs) are seamless nanometer scale tubes of graphite sheets with fullerene caps. Carbon nanotubes may be multi-walled or single walled. Single walled carbon nanotubes are generally either of the metallic-type or the semiconducting-type. CNTs have shown promise for nanoscale electronics, chemical sensors, biological imaging, high strength materials, field emission arrays, tips for scanning probe microscopy, gas storage, photonics, and other important applications. The realization of the potential of CNTs for these and other applications will depend on the availability of bulk quantities of CNTs having uniform properties.

Most synthetic methods for producing CNTs (arc and laser techniques, carbon vapor deposition, catalytic cracking of hydrocarbons, catalytic disproportionation of carbon monoxide, for example) result in mixtures (of metallic and semiconducting CNTs) that have a broad range of nanotube chiralities and energy bandgaps. Mixtures of CNTs are generally unsuitable for nanoscale electronics and other applications because the properties of CNT mixtures are not uniform. No method to date yields a product of only semiconductor-type or metallic-type nanotubes. In addition, no method to date is capable of producing a single chirality of carbon nanotubes.

There have been reports related to the separation of mixtures of CNTs into fractions of pure metallic and semiconductor CNTs, and to the preparation of chirally enriched samples of CNTs. The most successful approach to date involves an expensive DNA wrapping procedure that yields samples enriched in a chirality associated with a large bandgap energy. This DNA wrapping procedure, however, is not general for producing pure samples of CNTs having other chiralities. In addition, there is no current method for providing chirality-enriched samples of CNTs on a bulk (kg or greater) scale.

### SUMMARY OF THE INVENTION

In accordance with the purposes of the present invention, as embodied and broadly described herein, the present invention includes a medium for separating carbon nanotubes. The medium includes a support and a chemical group that is attached to the support and is capable of forming a complex with carbon nanotubes.

The invention also includes a method for separating carbon nanotubes. The method involves exposing a suspension of a mixture of carbon nanotubes to a separation medium comprising a support and a chemical group attached to the support and capable of forming a complex with carbon nanotubes, and thereafter separating the suspension from the separation medium.

The invention also includes a method for separating carbon nanotubes, comprising sending a liquid comprising carbon nanotubes through a column comprising a separation medium, the separation medium forming complexes with at least a portion of the carbon nanotubes in the liquid, collecting liquid that comprises nanotubes that did not form complexes with the separation medium, thereafter exposing the column to a reagent that dissociates the complexes and releases carbon nanotubes from the separation medium, and collecting the carbon nanotubes that are released from the separation medium.

The invention also includes a kit for separating carbon nanotubes based on chirality. The kit includes carbon nanotubes; a composition for forming a suspension of carbon nanotubes; a column of separation medium comprising reactive functionalities that form complexes with carbon nanotubes; and a reagent that dissociates complexes formed between carbon nanotubes and said separation medium.

The invention also includes a kit for separating carbon nanotubes based on chirality, said kit comprising a liquid that comprises carbon nanotubes; and a column of separation medium comprising reactive functionalities that form complexes with carbon nanotubes; and a reagent that dissociates the complexes and releases the carbon nanotubes from the separation medium.

The invention also includes a kit for separating carbon nanotubes based on their chirality, said kit comprising a liquid that comprises carbon nanotubes; a medium that comprises reactive functionalities that react and form complexes with carbon nanotubes; and means for separating liquid from said medium.

### BRIEF DESCRIPTION OF THE DRAWINGS

The accompanying drawings, which are incorporated in and form a part of the specification, illustrate embodiments of the present invention and, together with the description, serve to explain the principles of the invention. In the drawings:

FIG. 1 shows a fluorescence spectrum for a mixture of carbon nanotubes (CNTs). Each major peak of the spectrum is associated with a CNT chirality that gives rise to that peak. FIG. 1 also shows the reduction potential for valence and conduction bands of each of the chiralities, and the reduction potentials of several common oxidizing agents.

FIG. 2 shows a scheme for separating a chirally enriched fraction of CNTs from a CNT mixture.

FIG. 3a-d show simulated fluorescence spectra of chirally enriched CNT fractions that may be separated from a CNT mixture (inset spectrum of FIG. 3a) using an embodiment of the present invention.

FIG. 4a-b show simulated fluorescence spectra of chirally enriched CNT fractions that may be separated from a CNT mixture (inset spectrum if FIG. 4a) using another embodiment of the present invention.

FIG. 5a-d show simulated absorbance spectra of chirally enriched CNT fractions that may be separated from a CNT mixture in an embodiment of the invention based on the relative reaction rates of CNTs with separation medium.

FIG. 6 shows an embodiment preparation of a separation medium of the invention.

FIG. 7 shows another embodiment preparation of a precursor for separation media of the invention.

FIG. 8 shows yet another embodiment preparation of precursors for separation media of the invention.

FIG. 9 shows an embodiment supported separation medium of the invention.

### DETAILED DESCRIPTION

The present invention is concerned with the preparation of samples of CNTs having an enriched chirality. The invention is also concerned with kits for separating mixtures of CNTs into fractions that are enriched in one or more chiralities. The invention may be used to produce a sample that is enriched in a single CNT chirality for any desired semiconductor CNT bandgap energy.

The invention is also concerned with a separation medium for separating CNTs into fractions that are enriched in one or more chiralities. The separation medium used with the invention reacts with CNTs in what is believed to be a redox-type chemical reaction, where the separation medium either accepts electrons from the CNTs or donates electrons to the CNTs. In either case, there is believed to be a transfer of electrons that results in the formation of complexes. When such a complex forms, the CNTs that participate in the redox reaction become attached to the separation medium in a chirally selective manner.

The invention is also concerned with a method of using the separation medium to separate a mixture of CNTs into chirality-enriched fractions. The method is rapid and can be used to separate mixtures of CNTs on a kilogram scale, or higher. Separation of CNTs into fractions enriched in a single chiralty is important for developing applications in areas such as, but not limited to, nanoelectronics, sensors, imaging, tagging, photonics and smart materials applications.

Some of the description that follows outlines a basis for the chiral selectivity of the separation of a CNT mixture into chirally enriched fractions, and also illustrates some factors that are considered when choosing a separation medium for separating a given mixture of CNTs into fractions having an enriched chirality.

The choice of separation medium used for a separation depends on the composition of the mixture of CNTs to be separated. The composition of the mixture of CNTs may be determined after acquiring suitable spectra (fluorescence, absorbance, and/or Raman spectra) of the CNT mixture.

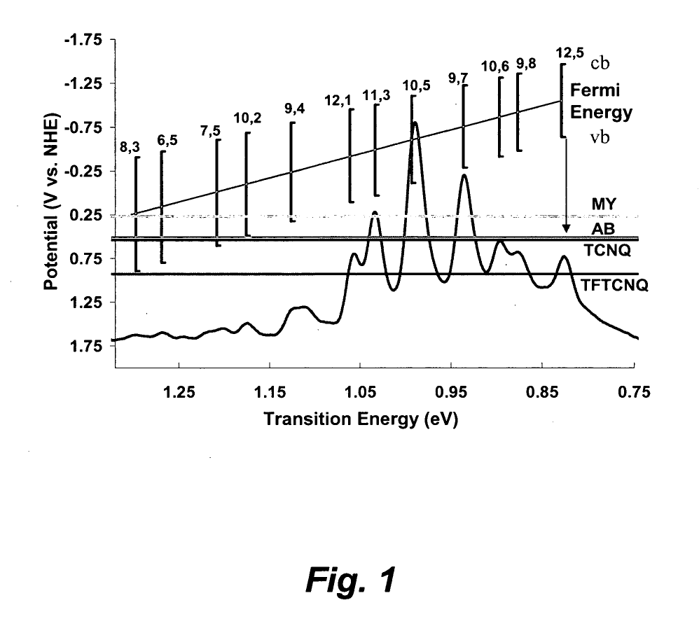

FIG. 1 shows a fluorescence spectrum for a suspended mixture of semiconducting CNTs plotted as reduction potential of the CNTs vs. their bandgap transition energy. The bandgap transition energies for the CNT chiralities in the CNT mixture shown in FIG. 1 are in the range of from about 0.8 eV to 1.35 eV. The diameters of these CNTs are in the range of from about 1.2 nm to about 0.6 nm. Each major peak in the spectrum is associated with a unique CNT chirality. Each unique chirality is designated by an (n,m) index that defines the nanotube geometry. The CNT chiralities shown in FIG. 1 are the (8,3), (6,5), (7,5), (10,2), (9,4), (12,1), (11,3), (10,5), (9,7), (10,6), (9,8), and (12,5) chiralities. The peak at 0.82 eV, for example, is associated with the CNT having the (12,5) chirality.

A separation medium is chosen for a mixture of CNTs so that the separation medium will tend to form complexes with a select range of chiralities present in the mixture. The portion of the CNT mixture that forms complexes with the separation medium will depend on the relative reduction potentials of the CNTs and of the separation medium.

FIG. 1 includes the reduction potentials for the valence band (vb) and conduction band (cb) of each of the CNT chiralities. FIG. 1 also includes the reduction potentials of several common oxidizing agents: mordant yellow (MY, 0.26 V vs. the normal hydrogen electrode (NHE)), azobenzenedisulfonic acid (AB, about 0.5 V), tetracyanoquinone (TCNQ, about 0.5 V), and TFTCNQ (about 0.95 V). According to FIG. 1, AB, for example, would not be expected to oxidize nanotubes having a bandgap larger than about 1.2 eV. In practice, significant reaction with AB (as an electron acceptor) was found to occur only for CNTs having a transition energy less than or equal to that of the (7,5) nanotube (as monitored by bleaching of spectral intensity from all bands with energies less than or equal to 1.2 eV). By contrast, reaction with MY as an electron acceptor is expected to occur for CNTs having bandgaps of about 1.1 eV or lower. In practice, effective spectral bleaching using MY was found to occur for nanotubes having a bandgap of less than about 1.15 eV.

It should be noted that the charge-transfer reactions between the acceptor molecules (AB, for example) and CNTs are reversible; subsequent addition of charge donors to the reacted samples converts the charge transfer complexes (AB-CNT complexes, for example) back to the uncomplexed species (AB and CNT).

A basis for the separation of a CNT mixture into chirally enriched fractions according to the invention is derived on an observation of an apparent correlation between the reduction potential of single walled carbon nanotubes (SWNTs) and their bandgap energy. Turning again to FIG. 1, it should be appreciated that as the bandgap of the SWNTs increases, the reduction potential also increases. With this in mind, a separation medium of an appropriate reduction potential may be designed for separating chirally enriched CNT fractions from the mixture. The design of such a separation medium generally involves chemically attaching a suitable redox molecule to a support. A separation medium may thus be constructed with a reduction potential selected for separating CNTs with specific chiralities from the CNT mixture.

According to FIG. 1, a separation medium of the invention with the reduction potential of TFTCNQ will tend to form complexes with all of the CNT chiralities. By contrast, a separation medium with the oxidizing properties of MY will react with a narrower range of chiralities, and will therefore be more selective at forming complexes of CNTs. A separation medium with the reduction potential of AB or TCNQ will form complexes with a broader range of CNT chiralities than those formed using MY as an acceptor, but with a narrower range than for TFTCNQ. By adjusting the reduction potential of the separation medium, the range of reacted CNT chiralities that form complexes with the media can be tuned.

According to the invention, a plurality of separation media of different reduction potentials may be used in tandem with a mixture of CNTs to produce a fraction having CNTs of a single chirality.

It will be appreciated that the individual peaks of the CNT fluorescence spectrum of FIG. 1 (or of an appropriate absorbance and/or Raman spectrum) may be used to monitor the chiral distribution of a CNT mixture as it is being separated into fractions having enriched chirality. The presence of a peak provides evidence that the mixture (or a subsequent fraction of the mixture) includes the CNT chirality that produces the peak. Conversely, the absence of a particular peak indicates that the mixture (or a subsequent fraction of the mixture) does not include that particular chirality. When the method of the invention is used with a mixture of CNTs, the relative reduction and/or enhancement of peaks in the spectrum may be used to provide an indication of changes in the CNT composition.

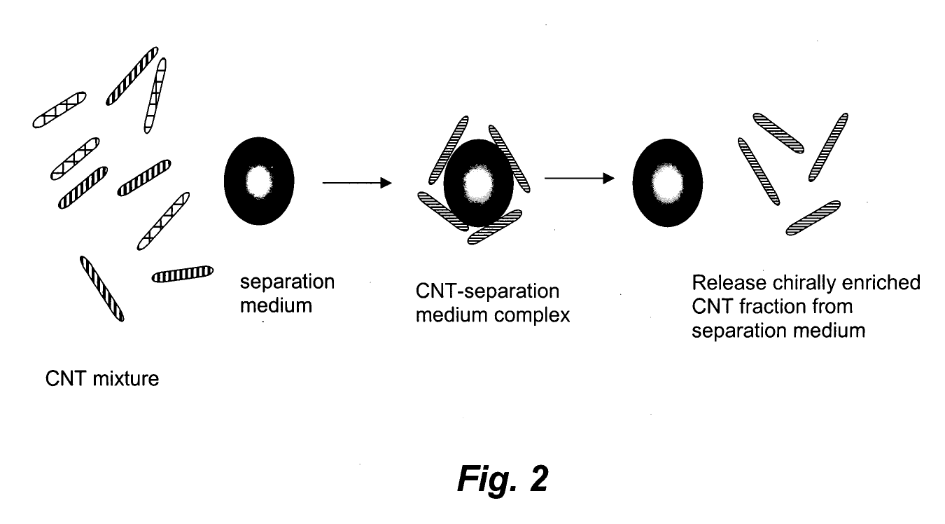

FIG. 2 depicts an embodiment method for separating a chirally enriched fraction of CNTs from a CNT mixture. According to FIG. 2, separation medium of the invention is combined with a liquid solution (or suspension) of a mixture of CNTs. After some period of time, the separation medium reacts with some of the CNTs of the mixture. The CNTs that react with the separation medium become attached to the separation medium. The CNTs that do not react with the separation medium remain in the liquid solution or suspension. These unreacted CNTs are isolated by centrifugation, dialysis, filtration, or by some other appropriate means of separating solid (or gel) from liquid. The separation medium is then treated with a reagent that releases the CNTs from the separation medium. This reagent may be a charge-donating reagent (NADH, sodium borohydride, and the like). The result of applying the method to the mixture of CNTs is the production of fractions where each includes a range of chiralities that is narrower than the range of chiralities of the CNT mixture. A fluorescence spectrum of each fraction may be compared to a fluorescence spectrum of the original mixture, if desired. Each of these fractions may be subjected to the method one or more additional times, or until fractions with the desired chiralities are obtained.

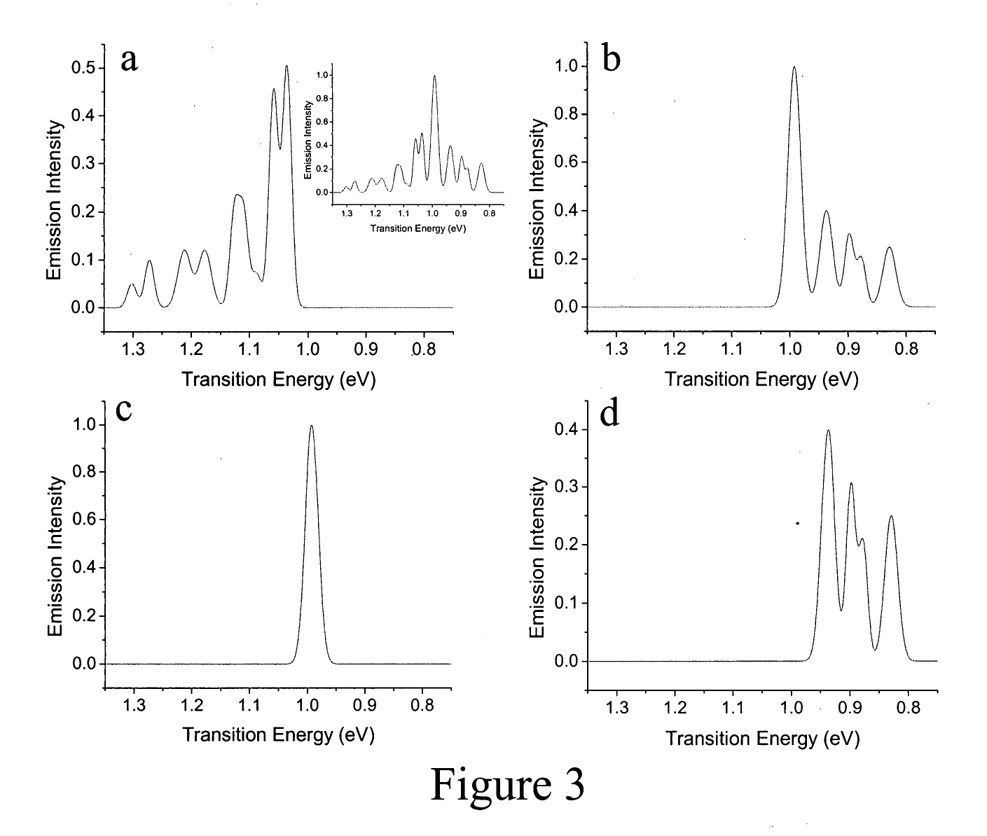

In an embodiment, a separation medium with a reduction potential of +0.2 V is (vs. NHE) is combined with a liquid solution or suspension of a mixture of CNTs. After reaction between the CNTs and the separation medium (of beads, for example), the liquid remaining, which contains the unreacted CNTs, is isolated from the separation medium by centrifugation, dialysis, filtration, or some other method capable of separating solid (or gel) from liquid. The separation medium is then treated with a reagent (such as NADH or some other reducing agent) that releases the carbon nanotubes from the beads. A resulting fraction A displays the fluorescence spectrum shown in FIG. 3a, and a second fraction B displays the fluorescence spectrum shown in FIG. 3b. Fraction B is then reacted with a separation medium having a reduction potential of −0.2 V (vs. NHE). After this second reaction between the CNTs and the new separation medium, the liquid remaining, which contains the unreacted CNTs (fraction C), is isolated from the separation medium by centrifugation, dialysis, filtration, or some other method capable of separating solid (or gel) from liquid. The separation medium is then treated with a reagent (such as NADH or some other reducing agent) that releases the carbon nanotubes from the beads. The newly released set is called fraction D. Fraction C displays a fluorescence spectrum shown in FIG. 3c, and fraction D displays a fluorescence spectrum shown in FIG. 3d. As can be seen from a comparison of FIG. 3c with FIG. 1, this embodiment allows the isolation of a nearly pure sample (i.e. fraction C) of (10,5) chirality, while fractions A and D are each comprised of much narrower chiral distributions than in the original mixture.

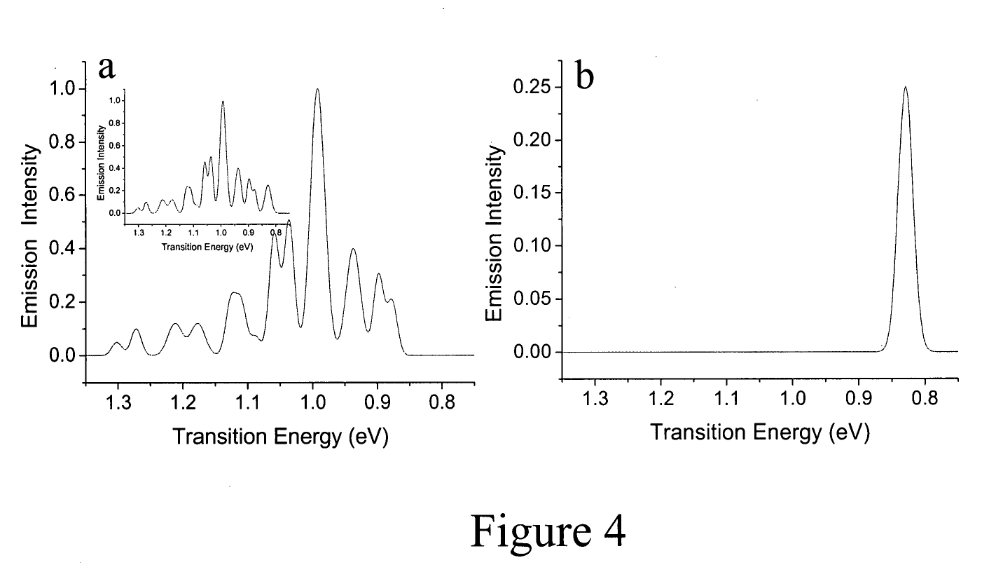

In another embodiment, a separation medium having a reduction potential of −0.5 V (vs. NHE) is combined with a liquid (a solution or suspension) having a mixture of CNTs. After reaction between the CNTs and the separation medium, the liquid remaining, which contains the unreacted CNTs, is isolated from the separation medium by centrifugation, dialysis, filtration, or some other method capable of separating solid (or gel) from liquid. The separation medium is then treated with a reagent (such as NADH or some other reducing agent) that releases the carbon nanotubes from the beads. The resultant nanotube fractions (fraction E and fraction F) display the fluorescence spectra shown in FIG. 4a and FIG. 4b, respectively. As can be seen from a comparison of FIG. 4b with FIG. 1, this embodiment allows the isolation of a nearly pure sample (fraction F) of (12,5) chirality.

The two embodiments described above are intended to show how the separation method can be used to isolate intermediate and large diameter nanotubes from a CNT mixture of diverse chiralities.

In another embodiment, a solution or suspension of CNTs is passed through a column of separation medium. The column of separation medium of this embodiment is sometimes referred to in the art as a stationary phase. Typically, a moving phase (a liquid that the CNTs are soluble in) is also used. At least a portion of the CNTs becomes attached to the separation medium. The effluent, which includes CNTs that do not react with the separation medium, is saved as one fraction. While not intending to be bound by any particular explanation, it is believed that nanotubes that react with the activated separation medium do so by forming charge transfer complexes with the activated separation medium. The formation of these complexes is reversible, and when the bound complexes are exposed to certain reagents (NADH, sodium borohydride, other organic or inorganic reducing agents, for example), the complexes are disrupted, resulting in the release of CNTs from the activated separation medium. These reagents are typically electron-donating reagents that displace the carbon nanotubes on the separation medium. The result is two fractions: a fraction that includes the nanotubes that remain in the recovered solution/suspension, and another fraction that includes the nanotubes released from the separation medium. Each fraction includes a range of chiralities that is narrower than the range of the original carbon nanotube solution/suspension. Each of these fractions may be subjected to additional separations until fractions with the desired chiralities are obtained.

In another embodiment of the invention concerned with separating a mixture of CNTs into fractions of enhanced chirality, a choice of an appropriate separation medium is based on the observed rate of reaction between CNTs and a variety of soluble charge transfer reagents. In this embodiment, the observed rate is of reaction appears to depend on the chirality of the individual carbon nanotubes (see M. J. O'Connell et al. in “Chiral Selectivity in the Charge Transfer Bleaching of Single-Walled Carbon Nanotube Spectra,” Nature Materials, Nature Publishing Group, pp. 1-7, April 2005, incorporated by reference herein). According to O'Connell et al., selective and reversible reactions between soluble charge transfer reagents and a suspension of a mixture of CNTs were determined to depend on the relative concentrations of charge-transfer reagent and CNTs. The distribution of reacted vs. unreacted chiralities could be adjusted or tuned by adjusting the relative amounts of reagents and CNTs. The reaction rate between CNTs and separation medium of the present invention may depend on the relative amounts of separation medium and CNTs used.

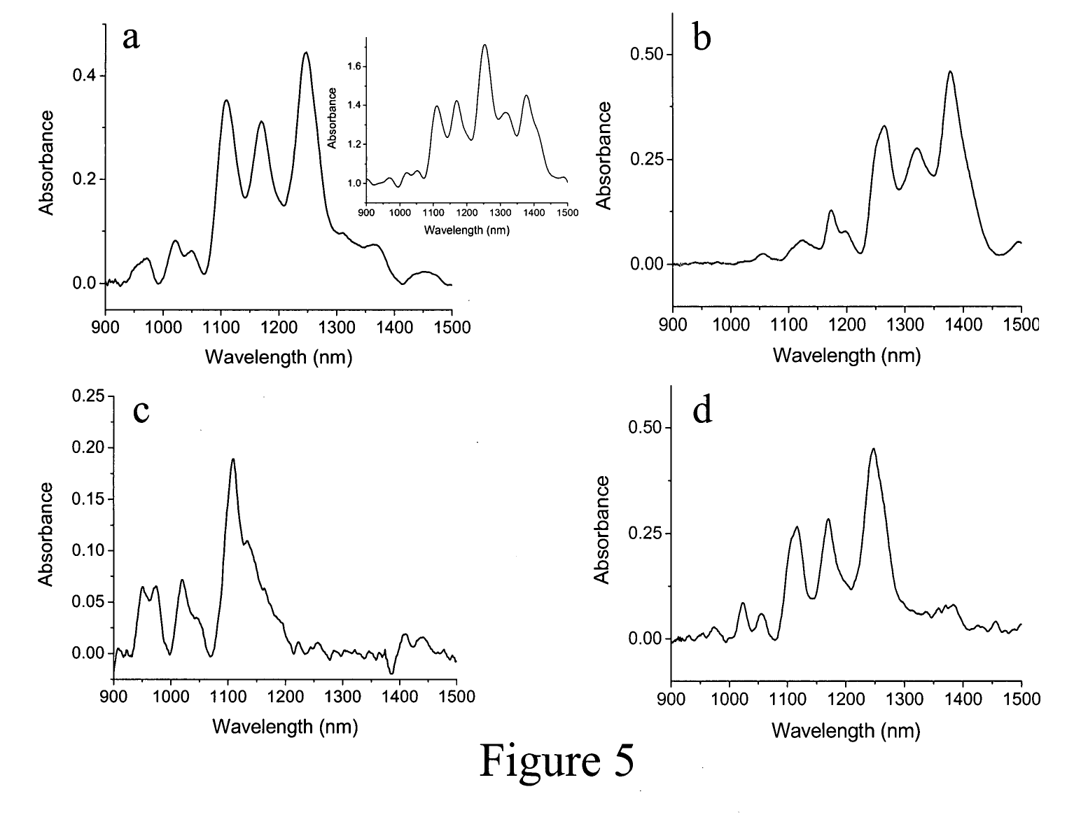

In an embodiment for separating a mixture of CNTs into chirally enriched fractions based on the reaction rates between CNTs and separation medium, a chosen amount of separation medium with reduction potential of +0.6 V (vs. NHE) is added to a solution or suspension of a CNT mixture. After a period of time, a reaction between at least some of the CNTs and the separation medium occurs where the CNTs that react with the separation medium become attached to the separation medium. The CNTs that do not react remain in the liquid solution or suspension and are isolated from the separation medium by centrifugation, dialysis, filtration, or some other means capable of separating solid (or gel) from liquid. Afterward, the CNTs that have become attached to the separation medium are released by treatment with a reagent such as NADH or some other reducing agent. The resulting nanotube fractions, fraction G and fraction H, display absorbance spectra similar to those shown in FIG. 5a and FIG. 5b, respectively. Fraction G is then exposed to a fresh sample of an even greater amount of the same separation medium, and the unreacted CNTs that remain in the solution or suspension, (i.e. fraction I), are isolated from the separation medium by centrifugation, dialysis, filtration, or some other method capable of separating solid (or gel) from liquid. The separation medium is then treated with a reagent (such as NADH or some other reducing agent) that releases the carbon nanotubes from the separation medium to generate another fraction, Fraction J.

Fraction I and fraction J display absorbance spectra of those shown in FIGS. 5c and 5d, respectively. As can be seen from a comparison of FIG. 5c with FIG. 1, fraction I is enriched in the (12,1) and (11,3) chiralities, while fraction G and fraction H are comprised of much narrower chiral distributions than in the original CNT mixture.

It may be appreciated from the above description that the separation of a mixture of CNTs into chirally enriched fractions depends on the availability of the appropriate separation medium for achieving the separations. A separation medium of the invention may be prepared by attaching to a support one or more chemical groups capable of undergoing a complex forming reaction with CNTs. A preferred reaction medium of the invention incorporates the reactivity of the reactive, complex forming chemical group with the stability and inertness of the support. Supports provide the separation media with the properties such that they can be separated from liquid solutions and suspensions by centrifugation, filtration, dialysis, and/or some other method useful for separating liquids from solids or gels.

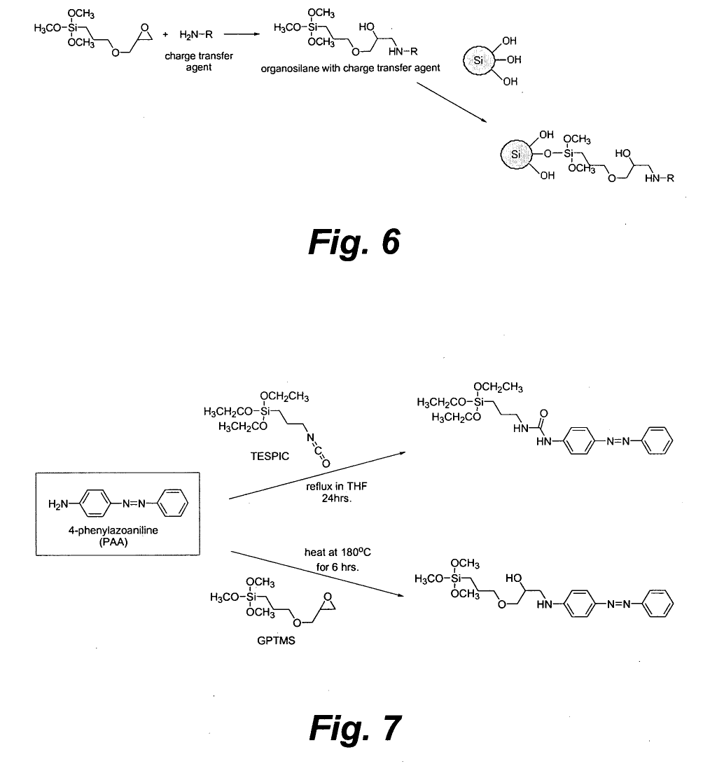

Examples of supports useful for forming a separation medium of the invention include, but are not limited to, polymers, glass beads, gels (silica gel, agarose gel, for example), metal particles (gold particles, for example), silica, and the like. An exemplary preparation of a separation medium employing silica gel particles as a support is shown in FIG. 6. In this embodiment, the separation medium includes a reactive group that is capable of forming a complex with CNTs. As shown in FIG. 6, a separation medium of this type may be synthesized by first preparing a molecule having both a CNT complex-forming group and a silyl ether group. When the molecule is reacted with silica gel beads, it is believed that the silyl ether group of the molecule reacts with silanol groups on the beads, which results in formation of a separation medium. CNT complex-forming groups having a wide range of reduction potentials may be attached to a silica support this way. The resulting separation media are capable of separating mixtures of CNTs into fractions having an enriched chirality.

Preparations of precursors for generating separation media useful with the invention are shown in FIG. 7. In each of these, a molecule having both an azobenzene-type group and a silyl ether group is prepared. One involves reacting 4-phenylazoaniline (PAA) with triethoxysilylpropyl isocyanate (TESPIC) (FIG. 7, upper reaction). The reaction likely involves heating PAA and TESPIC to reflux in anhydrous tetrahydrofuran (THF) for about 24 hours. The product of the reaction is then crystallized by addition of hexane, and then cooling. In the lower reaction shown in FIG. 7, PAA and glycidoxypropyltrimethoxysilane (GPTMS) are combined and heated for a few hours at a temperature of about 180 degrees Celsius. The products of both reactions can be attached to silica gel beads (the support). It is believed that the separation medium forms upon reaction of the silyl ether group of the product molecule with silanol groups of the silica gel beads.

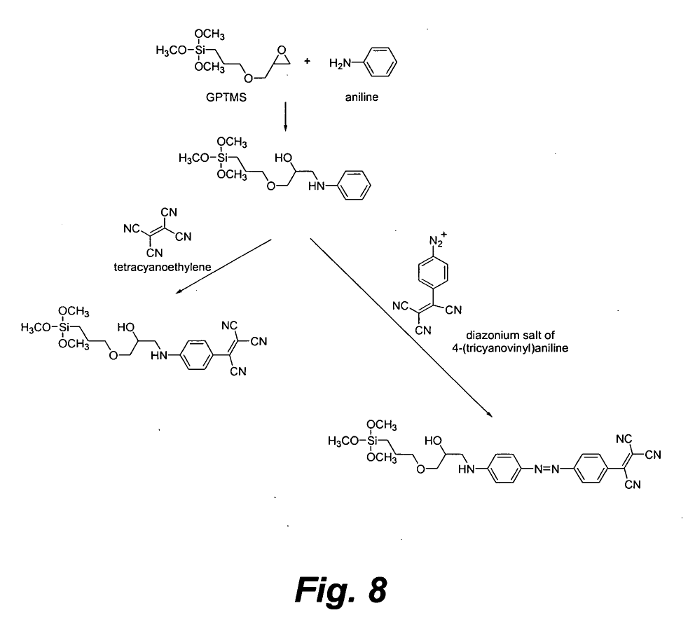

Other embodiment preparations of precursors for generating separation media useful for chiral separation of CNTs are shown in FIG. 8. These embodiment preparations yield a molecule having a tricyanovinyl group. A series of tricyanovinyl-containing organosilanes may be prepared by reacting aniline with glycidoxypropyl-trimethoxysilane (GPTMS) for a few hours at elevated temperatures. The resulting organosilane is reacted with tetracyanoethylene, preferably recrystallized tetracyanoethylene, (FIG. 8, below right), or with the diazonium salt of 4-(tricyanovinyl)aniline (FIG. 8, below left). The product molecules are then reacted with silica gel beads to produce separation media of the invention.

A wide range of available redox reactive groups may be incorporated into separation media of the invention, and it should be understood that the invention is not limited to the few examples described above. It should also be understood that the redox reactive groups that can be combined with support materials to form separation media of the invention are not limited to the above examples, but may also include, for example, napthalenes, anthracenes, viologens, porphyrins, tetracyanoquinone and pyrene analogues, transition metal coordination complex species, and the like.

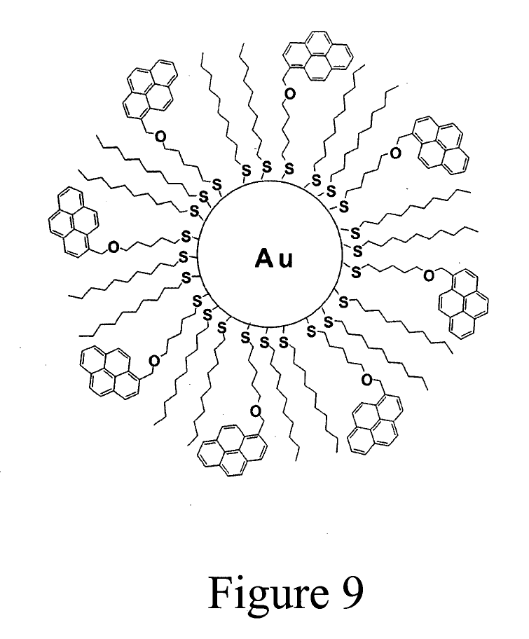

The attachment of redox active groups of differing reduction potentials to supports yields separation media with tuned reduction potentials that may be selected for separating a mixture of CNTs into fractions having predetermined chiral distributions. A preferred separation medium useful for separating CNT mixtures into fractions of enriched chirality includes metal particles having attached groups that participate in the formation of complexes with CNTs. These types of separation media may be prepared by forming a self-assembled monolayer (SAM) on metallic microparticles or nanoparticles. An example of such a separation medium is shown in FIG. 9. Preferred metals include gold and silver. Gold is most preferred because of its chemical inertness, among other reasons. The SAM forms when the metal particles are exposed to a variety of functionalized organic molecules, such as but not limited to, amines, thiols, isothiocyanates and silanes. The functionalized organic molecules useful with this invention include a chemical group that is believed to form a redox-type complex with CNTs. These groups include, but are not limited to, azobenzene-type groups and tricyanovinyl-groups, and other groups mentioned previously.

The present invention is also concerned with kits useful for separating a mixture of CNTs into fractions of enriched chiralty. An exemplary kit of the invention includes a composition for forming a suspension of carbon nanotubes, and a column of separation medium for performing the separation, where the separation medium is of a type previously described having reactive functionalities that form complexes with carbon nanotubes. The kit also includes a reagent that dissociates complexes formed between carbon nanotubes and the separation medium.

Another exemplary kit of the invention for separating carbon nanotubes based on chirality includes a liquid suspension of carbon nanotubes, a column of separation medium for performing the separation of the carbon nanotubes into chirally enriched fractions, and a reagent that dissociates complexes formed is between the separation medium and the carbon nanotubes. A separation medium useful with this type of kit may include a charge transfer agent covalently bonded to a support.

Yet another exemplary kit of the invention for separating carbon nanotubes based on their chirality includes a liquid comprising carbon nanotubes, a medium comprising reactive functionalities that react and form complexes with carbon nanotubes, and means for separating liquid from said medium. The means for separating the liquid from the medium may include a filter means, a centrifuge means, dialysis means, or combinations thereof. It should be understood that the kit is not meant to be limited to any of these examples, and can include any means capable of separating liquid from the separation medium.

In summary, the invention includes a separation medium and method that uses the separation medium to separate a mixture of carbon nanotubes into fractions having enriched chirality. The invention also includes kits useful for separating a mixture of carbon nanotubes into chirally enriched fractions. The invention may be scalable to kilogram and even much larger quantities, and can be performed in either batch or continuous flow processes. The separation method of the invention is rapid, can provide more highly resolved separations than those achievable using current methods, and can be used to isolate nanotubes of a single chiralty. In contrast to DNA-based separations, where the separations chemistry is limited only to the smallest diameter chiralities, the invention can be used to access any range and breadth of chirality. The separation selectivity stems from the varying reactivity of each nanotube type based on diameter and chirality-dependent differences in bandgap and electronic properties. Chiral selectivity in the redox reaction is believed to result from bandgap dependence in the electron-transfer thermodynamics and/or from the rate of reaction of carbon nanotubes with a separation medium of the invention. The present invention is believed to provide the first method capable of providing an enriched fraction of large diameter CNT chiralities from a mixture of CNTs. In addition, the reagents used with the invention are readily accessible and less expensive than reagents required for DNA-based is separations. The final distributions of the CNTs may be controlled by adjusting the reduction potential of the separation medium, and/or by adjusting the relative concentrations of the CNTs and the separation medium, making this a highly tunable separation method.

The foregoing description of the invention has been presented for purposes of illustration and description and is not intended to be exhaustive or to limit the invention to the precise form disclosed, and obviously many modifications and variations are possible in light of the above teaching.

The embodiments were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed is:

1. A medium for separating carbon nanotubes, said medium comprising a support and a chemical group that is attached to the support, said medium capable of selectively forming complexes with carbon nanotubes.

2. The medium claim 1, wherein said support is selected from the group consisting of polymers, gels, glass, and metal.

3. The medium of claim 1, wherein said support comprises metal particles.

4. The medium for separating carbon nanotubes of claim 1, wherein said chemical group is at least one selected from the group consisting of azobenzenes, tricyanovinyls, napthalenes, anthracenes, viologens, porphyrins, tetracyanoquinones, pyrenes, and transition metal coordination complex species.

5. A method for separating carbon nanotubes, comprising exposing a suspension of a mixture of carbon nanotubes to a separation medium comprising a support and a chemical group attached to the support, said separation medium capable of selectively forming complexes with carbon nanotubes, and thereafter separating the suspension from the separation medium.

6. The method of claim 5, wherein the separation medium is separated from the suspension by a method selected from the group consisting of centrifugation, dialysis, filtration, or combinations thereof.

7. The method of claim 5, further comprising the step of treating the separation medium with a charge-donating reagent after exposing the separation medium to the mixture of carbon nanotubes.

8. The method of claim 5, wherein the step of exposing a suspension of carbon nanotubes to a separation medium comprises passing a suspension of carbon nanotubes through a column of the medium, whereby at least a portion of the carbon nanotubes form a complex with the charge transfer molecules covalently attached to the support and a portion that does not form a complex is eluted from the column as effluent.

9. A method for separating carbon nanotubes based on their chirality, comprising:
sending a liquid comprising carbon nanotubes through a column comprising a separation medium that forms complexes with at least a portion of the carbon nanotubes in the liquid;
collecting the portion of the liquid comprising nanotubes that do not form complexes with the separation medium;
thereafter exposing the column to a reagent that dissociates the complexes of carbon nanotubes and releases the carbon nanotubes from the separation medium; and
collecting the carbon nanotubes that are released from the separation medium.

10. The method of claim 9, wherein the separation medium comprises azobenzenes, tricyanovinyls, napthalenes, anthracenes, viologens, porphyrins, tetracyanoquinones, pyrenes, transition metal coordination complex species, or combinations thereof.

11. A kit for separating carbon nanotubes based on chirality, comprising:
a composition for forming a suspension of carbon nanotubes;
a column of separation medium comprising reactive functionalities that form complexes with carbon nanotubes; and
s a reagent that dissociates complexes formed between carbon nanotubes and said separation medium.

12. The kit of claim 11, wherein said kit further comprises carbon nanotubes.

13. A kit for separating carbon nanotubes based on chirality, comprising:
a liquid suspension comprising carbon nanotubes;
a column of separation medium comprising reactive functionalities that form complexes with a portion of said carbon nanotubes; and
a reagent that dissociates complexes formed between the separation medium and carbon nanotubes.

14. The kit of claim 13, wherein said column of separation medium comprises charge transfer reagent covalently attached to a support.

15. The kit of claim 13, wherein said column of separation medium comprises diazonium functionalities.

16. A kit for separating carbon nanotubes based on their chirality, comprising:
a liquid comprising carbon nanotubes;
a medium comprising reactive functionalities that react and form complexes with carbon nanotubes; and
means for separating liquid from said medium.

17. The kit of claim 16, wherein said means for separating a liquid from said medium comprises a filter, a centrifuge, dialysis means, or combinations thereof.
